(19) United States
(12) Patent Application Publication
(10) Pub. No.: US 2009/0157609 A1
(43) Pub. Date: Jun. 18, 2009

(54) ANALYZING IMAGES TO DERIVE SUPPLEMENTAL WEB PAGE LAYOUT CHARACTERISTICS

(75) Inventors: Thomas Phan, San Jose, CA (US); Rajendra Shriwas, Fremont, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/955,231

(22) Filed: Dec. 12, 2007

(51) Int. Cl. G06F 7/06

(52) U.S. Cl. 707/3; 707/E17.108

(57) ABSTRACT

Methods and apparatus for automatically and dynamically constructing a web page having one or more images as the web page's major component are provided. The image(s) are analyzed based on a first set of rules to determine at least one relevant attribute, such as a relevant color. At least one aesthetic design element for the web page is automatically selected with reference to the at least one relevant attribute based on a second set of rules. The web page is automatically and dynamically constructed by incorporating the at least one aesthetic design element based on the second set of rules. The first set of rules includes at least one rule that governs the analysis of the image(s) and the determination of the relevant attribute(s). The second set of rules includes at least one rule that governs the selection and the incorporation of the aesthetic design element(s) for the web page.

### BACKGROUND OF THE INVENTION

The present invention relates to methods and computer program products for dynamically constructing a web page that has one or more images as the web page's major component. More specifically, the present invention relates to methods and computer program products for automatically analyzing the colors and other attributes of the image(s) to derive supplemental layout characteristics for the web page based on various rules.

Images have always been an important and integral part of every form of publication, such as newspapers, magazines, web pages, etc. With online publications, images play a significant role in both web page content and online advertising. Often, in order to improve the overall readability of the content or advertisements of the web pages and to grab users' attention, the online publishers may manually design and/or adjust the overall layout of the web pages in response to various attributes of the images displayed thereon, such as color scheme, shape, brightness, etc. Sometimes, the colors of the elements or components surrounding the images may be manually selected based on the images' color schemes in order to achieve an overall harmonious effect that is pleasing to the eye. Other times, certain colors are able to elicit various emotional responses from certain users, and these colors may be manually incorporated in the web page content or advertisements to help create the desired effect.

With today's sophisticated websites, most web pages are constructed dynamically. That is, a web page is constructed only when needed, i.e., when the web page is to be delivered to a user, and its content and layout usually vary based on the most current information available at the time of construction. For example, when a user visits Yahoo!® Travel's home page (http://travel.yahoo.com), the home page may show bargain offers or deals available at the time of the user's visit. Such bargain offers or deals change from time to time, and thus Yahoo!® Travel's home page is constructed dynamically to include the bargain offers or deals currently available at the time of the user's visit. Similarly, the advertisements displayed on the home page also vary from time to time and/or from user to user. As a result, the image(s) displayed on a dynamically constructed web page vary from time to time and/or from user to user.

With the great number of web pages being dynamically constructed at each website, it is impractical and perhaps impossible to manually determine the layout characteristics of each web page based on the image(s) displayed thereon every time such image(s) are changed. For example, Yahoo! delivers over one billion web pages per day. For many web pages, their content, including the images displayed thereon, may change within minutes or even seconds. In such cases, it would be impossible for the publishers to manually analyze the images and determine the layout of the web pages based on the results of the analysis every time an image is changed. As a result, many websites choose a default layout scheme for the web page; such a layout scheme may reflect the company's corporate colors or may be some generic combination. This default layout scheme may not be congruent with the image being displayed on the web pages and thus may not be pleasing to the users.

Moreover, manually analyzing images may introduce human errors. For example, when selecting a most-frequently occurring color from an image, the human eye may not be able to precisely distinguish between subtle shades of the same color. As a result, an incorrect color may be selected as the most-frequently occurring color.

### SUMMARY OF THE INVENTION

Broadly speaking, the present invention relates to systems and methods for dynamically constructing a web page that has one or more images as its major component(s). More specifically, the present invention automatically provides web page layouts tailored to the image(s) displayed thereon.

According to various embodiments, first, the image(s) to be displayed on the web page are analyzed based on a first set of rules to determine at least one relevant attribute. The first set of rules includes at least one relevant-attribute rule that governs the determination of the relevant attribute(s) of the image(s). For example, one relevant-attribute rule may specify that the relevant color is the most frequently-occurring color in the image(s).

Next, at least one aesthetic design element is automatically, i.e., without human intervention, selected for the web page with reference to the relevant attribute(s) of the image(s) and based on a second set of rules. The second set of rules includes at least one aesthetic-design-element rule that governs the selection of the aesthetic design element(s) with reference to the relevant attribute(s) of the image(s). For example, one aesthetic-design-element rule may specify that an augmenting color for the web page is the complementary color of the relevant color.

Based on the second set of rules, any element that may be displayed on an web page, including layout characteristics, may be derived with reference to the at least one relevant attribute. Such elements are familiar to those skilled in the relevant arts and include, but are not limited to, HyperText Markup Language (HTML) properties (including, for example, web page background color, border color, text orientation, text color, text font), Adobe Flash™ interface properties, Adobe Flash™ Player interface properties, Sun Java™ applet interface properties, and Microsoft Silverlight™ interface properties, etc.

Finally, the web page is automatically and dynamically constructed incorporating the aesthetic design element(s) based on the second set of rules. The web page components specified by the second set of rules are updated. And the final web page is optionally delivered to one or more users.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings in which like reference numerals refer to similar elements, and in which:

FIGS. 1A and 1B (prior art) illustrate two examples of a traditional 12-color wheel constructed with red, yellow, and blue as primary colors.

FIG. 1C (prior art) illustrate an example of a 12-color wheel constructed with red, green, and blue as primary colors.

FIG. 2 illustrates a method of automatically determining the layout characteristics for a web page based on the image(s) displayed thereon.

FIGS. 3A and 3B illustrate a sample web page constructed using the method illustrated in FIG. 2.

FIGS. 4A and 4B illustrate a sample advertisement displayed on a web page constructed using the method illustrated in FIG. 2.

FIG. 5 illustrates a system for automatically analyzing the image(s) displayed on a web page and determining the layout characteristics for the web page based on the results of the analysis.

FIG. 6 is a simplified diagram of a network environment in which specific embodiments of the present invention may be implemented.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

Color affects every aspect of the human life. Many cultures and religions use color symbolically or associate different meanings with different colors. For example, some cultures connect white color with purity, peace, or innocence, black color with power, formality, or wealth, purple color with sensuality, spirituality, or creativity, etc. Different colors may also have different effects on human behavior and/or emotion. For example, to some people, blue color conveys the feeling of tranquility and calmness, while yellow color conveys joy and violet color conveys passion.

Because color has such important and strong influences on human beings, people often utilize color to help achieve various desirable results. With respect to designing web pages (including designing a web page's main content as well as the advertisements displayed thereon), the designers are usually cognizant of the overall color scheme and effect so that the web pages appear pleasing to the viewers. The designers may also use individual colors to direct users' attentions to certain important elements or components on the web pages using a variety of color theories (explained in more detail below). For example, analogous colors may be used to create a color harmony among related components on a web page. Complementary colors may be used to emphasize an important element on a web page. Warm colors may be used to stimulate the users and convey a feeling of liveliness, while cool colors may be used to calm and relax the users. These color theories may be applied when designing both the main content of a web page as well as the one or more graphical advertisements included in the web page.

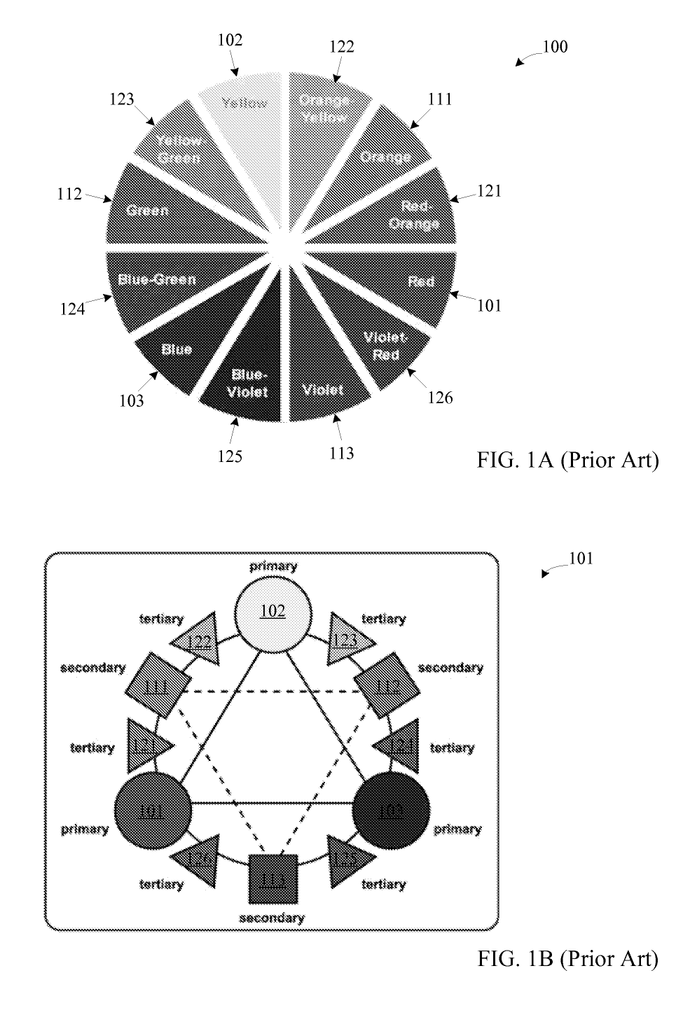

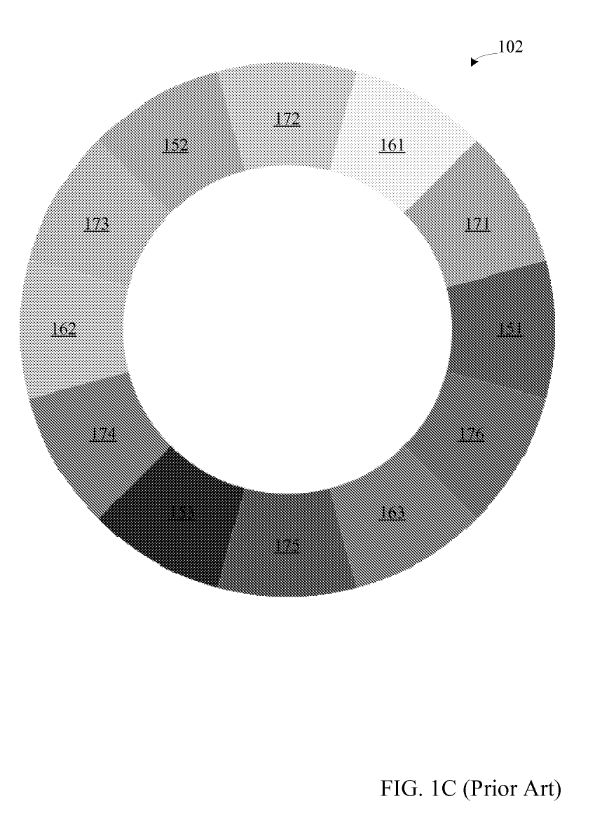

To explain a few basic concepts of the traditional color theory, FIGS. 1A and 1B (prior art) illustrate two examples of a traditional 12-color wheel 100. There are three primary colors: red 101, yellow 102, and blue 103. The secondary colors, orange 111, green 112, and violet 113, are each formed by mixing two primary colors respectively. The tertiary colors, red-orange 121, orange-yellow 122, yellow-green 123, blue-green 124, blue-violet 125, and violet-red 126 are each formed by mixing one primary color and one secondary color respectively.

Analogous colors are any three colors that are side by side on the color wheel 100, such as red 101, red-orange 121, and orange 111. Complementary colors are any two colors that are directly opposite each other on the color wheel 100, such as red 101 and green 112 or yellow 102 and violet 113. Mixing two complementary colors produces a neutral color, i.e., white, grey, or black. Color temperature is known to those skilled in the relevant arts as a metric that compares a color's chromaticity with a theoretical, heated black-body radiator. The color temperature is generally expressed in Kelvin degrees. Generally speaking, warm colors refer to hues from red through yellow, including browns and tans, and cool colors refer to hues from blue-green through blue-violet, including most grays.

The color wheels shown in FIGS. 1A and 1B are constructed using red, yellow, and blue as primary colors. With publications and computer graphics, often the primary colors are red, green, and blue. FIG. 1C (prior art) illustrate an example of a 12-color wheel constructed with red 151, green 152, and blue 153 as primary colors. Because the primary colors are different, the secondary and tertiary colors are also different. In this case, the secondary colors are yellow 161, cyan 162, and magenta 163. And the tertiary colors include orange 171, two shades of green 172, 173, one shade of blue 174, purple 175, and hot pink 176. In addition, the complementary color for red 151 is cyan 162, the complementary color for green 152 is magenta, and the complimentary color for blue 153 is yellow 161.

Depending on the requirements of the individual systems, different types of color wheels may be used, such as color wheels constructed with different sets of primary colors.

Various color theories may be used when designing web pages, especially web pages having one or more images as their major components. By analyzing the color scheme of the image(s), certain color theories or rules may be used to help select augmenting color(s) for the other component(s) on the web pages, especially those component(s) surrounding the image(s). It is generally regarded by those skilled in the relevant arts that the contrast between colors has a large impact on users' perception of the image, where contrast between two colors can be defined as the separation of the colors on the color wheel or the difference in brightness between the colors. Further, it is generally regarded that highly contrasting colors make an image more vibrant, while images with less contrast are considered more harmonic and sedate. Such rules may be used to determine the augmenting colors on a web page. For example, if it is determined that an image on a web page has a most-frequently occurred color of yellow, the complementary color of yellow, i.e., violet, may be selected for the border of the image to draw attention to the image itself. Similarly, if it is determined that an image on a web page has a lively predominant color, such as pink or orange, this information may be used to select an appropriate font, such as a font that appears playful, for the text on the same web page to establish a consistent overall theme.

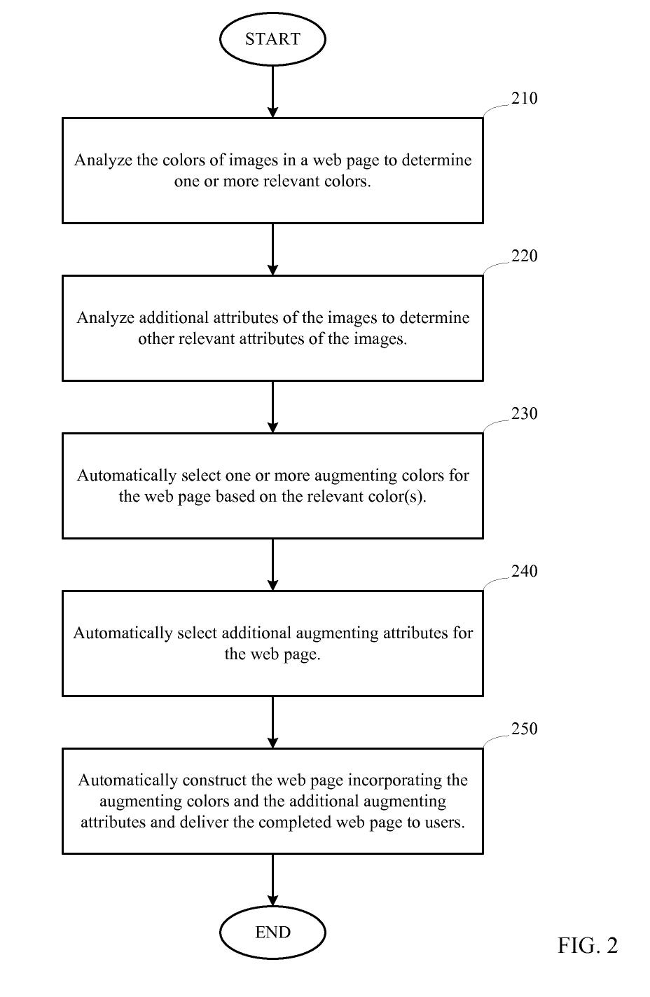

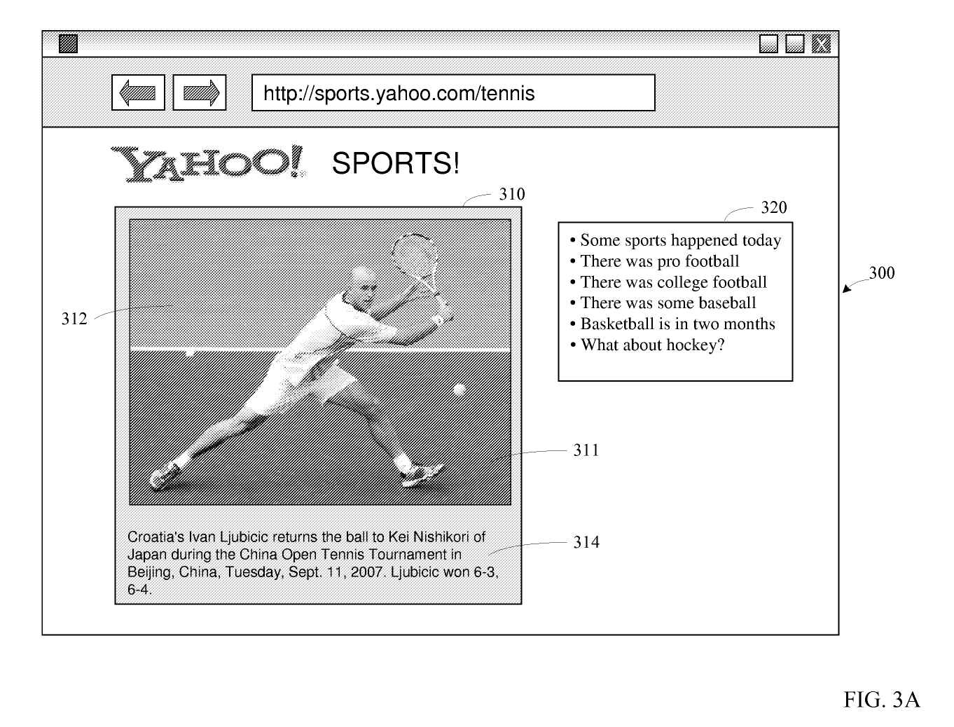

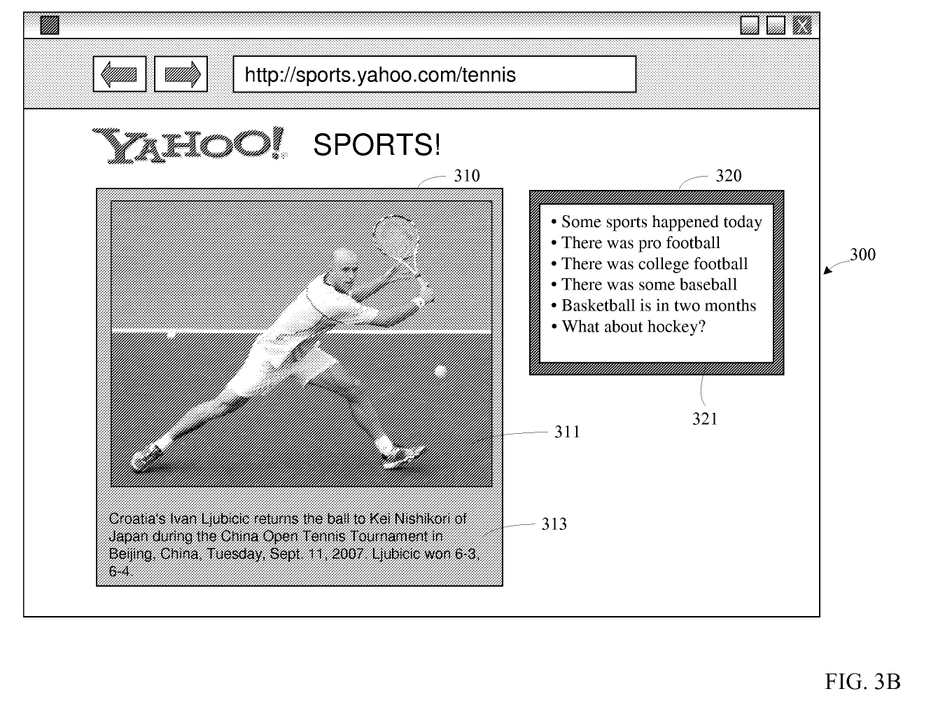

FIG. 2 illustrates a method of automatically determining the layout characteristics for a web page based on the image(s) displayed thereon according to one embodiment of the invention. The steps shown in FIG. 2 are explained in connection with a sample web page 300 illustrated in FIGS. 3A and 3B.

As discussed above, images have become an important and integral part of web pages. More often than not, a web page contains one or more images as its major or central elements. FIG. 3A illustrates a sample web page 300 that has one image 310 as one of its major components. Below to the image 310 are several lines of text 314 that convey some message and/or information about the image 310 and the topic of the web page. In this example, the web page 300 is about sports.

According to various embodiments, first, the colors of the image(s) included in a web page are analyzed based on a first set of rules to select one or more relevant colors, and the selection of the relevant color(s) is governed by one or more relevant-color rules included in the first set of rules (FIG. 2, step 210). For example, one rule may specify that the relevant color of an image is the color that occurs most frequently in the image. An alternative rule might specify that the relevant color of an image is the color in the largest single-color contiguous region. Yet another alternative rule may specify that the relevant color of an image is the image's darkest or brightest color. It will be understood that a wide variety of rules may be applied to determine a relevant color of an image without departing from the scope of the invention.

Furthermore, with these embodiments, the image analysis begins with selecting one or more relevant colors because often, color is considered a very important attribute of an image. However, it is not necessary that the image analysis always results in selecting at least a relevant color. According to other embodiments, it is possible that the image is analyzed to select various types of relevant attributes other than relevant color (see below with respect to step 220 for selection of other types of relevant attributes in an image).

The method used to analyze an image in order to determine its relevant color(s) may also vary considerably based on the actual rule(s) applied. For example, to determine the frequencies of the colors found in an image, a color histogram may be constructed for the image. To determine the darkness or brightness of the colors found in an image, the brightness of the pixels or the pixel values in the image may be used. To detect the shape of a particular region within an image, some type of edge detection or shape detection algorithm may be used. Therefore, as would be understood by those of skill in the art, appropriate methods for image analysis may be selected from a wide variety of methods based on the rule(s) specified.

The relevant-color rule(s) are selected and predefined based on the design needs or requirements of the web pages. There is no restriction on what may or may not be one of the relevant-color rules, and any color found in the image(s) may be designated as a relevant color. Thus, a color that occurs rarely in an image may still be designated as its relevant color if that is desirable for the specific application. Furthermore, there may be more than one relevant color for a web page if the relevant-color rule(s) so dictate.

In FIG. 3A, the image 310 shows a man playing tennis. Although the web page 300 only includes one image 310, the same theory applies when there are multiple images contained in a web page. For example, a relevant-color rule may specify that the average color or the most-frequently occurring color across all images is the relevant color for the web page.

In the image 310, the color of the floor of the tennis court is blue 311, and the color of the field around the tennis court is green 312. Suppose that for this web page 300, the relevant-color rule specifies that the most-frequently occurring color found in the image 310 is to be designated as the relevant color for the web page 300. By constructing a color histogram for the image 310, it may be determined that the blue color 311 of the tennis court is the most-frequently occurring color. Thus, in this example, the relevant color for the web page 300 is the blue color 311 of the floor of the tennis court.

Optionally, the image(s) may be further analyzed to select one or more additional relevant attributes, such as shape, brightness, region, etc. based on the first set of rules (e.g., FIG. 2, step 220). In addition to rules related to relevant colors as discussed above, the first set of rules may further include one or more other relevant-attribute rules that govern the selection of various relevant attribute(s) respectively. For example, one rule relating to the shape of the image may determine the shape of a particular region within the image. Another rule relating to the brightness of the image may determine whether the image has an average brightness above or below some threshold brightness. Another rule may identify the color that occurs in the region next to where in-image text would be added, which frequently occurs with advertisements. Various image analysis tools and/or methods may be utilized to obtain the necessary information.

The term “relevant attribute”, including the term “relevant color” since color is one of the attributes of an image, refers to an attribute of the image that is subsequently used to determine the “augmenting attribute” for the web page. What is designated as a relevant attribute is completely governed by the predefined relevant-attribute rule(s). More specifically, a relevant attribute is an attribute of the image that is relevant to the determination of one or more aesthetic design elements used in constructing the web page. In other words, a relevant attribute of an image is an attribute that is considered relevant to the overall design of the web page, and the aesthetic design element(s) for the web page are chosen with reference to one or more relevant attributes. Furthermore, what is considered relevant to one application may not be considered relevant to another application. Thus, the relevancy of the attributes is application-dependent.

Once the relevant attribute(s), including the relevant color(s), for the image(s) have been determined, one or more augmenting colors for the web page may be automatically selected based on the relevant color(s) and a second set of rules (FIG. 2, step 230). The second set of rules includes one or more augmenting-color rules that govern the selection and usage of the augmenting color(s) for the web page.

The augmenting color(s) are colors used in the web page that, when combined with the relevant color(s), create an intended effect. For example, one augmenting-color rule may specify that the augmenting color used for the border of the image is the complementary color of the relevant color found in the image, so that the image border draws attention to the image itself. Another augmenting-color rule may specify that the augmenting color used for the caption of the image is an analogous color that is five shades darker than the relevant color found in the image. And so on.

Again, the augmenting-color rule(s) are selected and predefined based on the design needs or requirements of the web pages. There is no restriction on what may or may not be an augmenting-color rule, and any color may be used as an augmenting color. Furthermore, there may be more than one augmenting colors in a web page if the augmenting-color rule(s) so dictate.

FIG. 3B illustrates the web page 300 shown in FIG. 3A with two augmenting colors incorporated therein. In this example, there are two augmenting-color rules. The first augmenting-color rule specifies that the border color 313 surrounding the image 310 is the complementary color of the relevant color 311 of the floor of the tennis court. Using the RGB (red-green-blue) pixel value of the relevant color 311, its complementary color may be calculated by subtracting each of the RGB values from 255. In this case, the augmenting color 313 used for the border of the image 310 is a yellowish green color.

The second augmenting-color rule specifies that the border color 321 surrounding the text block 320 is the same as the relevant color 311, i.e. the blue color of the floor of the tennis court.

Optionally, additional augmenting attributes, such as text font, text color, text size, image or text orientation, etc., may be selected for the web page based on the second set of rules (FIG. 2, step 240). The second set of rules may further include one or more other augmenting-attribute rules that govern the selection of various augmenting attribute(s) respectively. In fact, any property defined in the HyperText Markup Language may be selected as a part of the tailored layout scheme. For example, one augmenting-attribute rule may specify a particular text font in response to a particular relevant color found in the image, while another rule may specify a text orientation, e.g., horizontal or vertical, alignment, etc., in response to a particular relevant shape of the image. In addition, design attributes such as Adobe Flash™ interface properties, Adobe Flash™ Player interface properties, Sun Java™ applet interface properties, Microsoft Silverlight™ interface properties, etc. may be selected.

Sometimes, certain typeface fonts may subliminally convey different messages or feelings to the users. For example, some people may consider that the Helvetica font conveys a business or corporate image while the Old English font appears formal and elegant. Some of the script fonts may be considered lively or playful. Thus, a different font may be chosen for the text of a web page based on the relevant color(s) or other relevant attributes of the image(s) on the web page. A somber color, such as black, blue, or green, may work well with a relatively formal typeface font, such as Times New Roman, Bookman, or Tahoma, while a passionate color, such as pink or red, may work well with a relatively free-spirited font, such as Comic Sans MS.

Once the augmenting color(s) and optionally other augmenting attributes have been selected based on the second set of rules, the web page may be automatically constructed incorporating all the augmenting attributes and the final web page may be delivered to the users (FIG. 2, step 250). In this sense, the augmenting attribute(s) are the aesthetic design element(s) chosen for the web page. The second set of rules also governs how the augmenting attributes are to be used during the automatic construction of the web page. In FIG. 3B, the second set of rules not only specify how the augmenting colors 313, 321 are to be selected based on the relevant color 311, but which augmenting color is used for what element, i.e. augmenting color 313 used for the border of the image 310 and augmenting color 321 used for the border of the text 320.

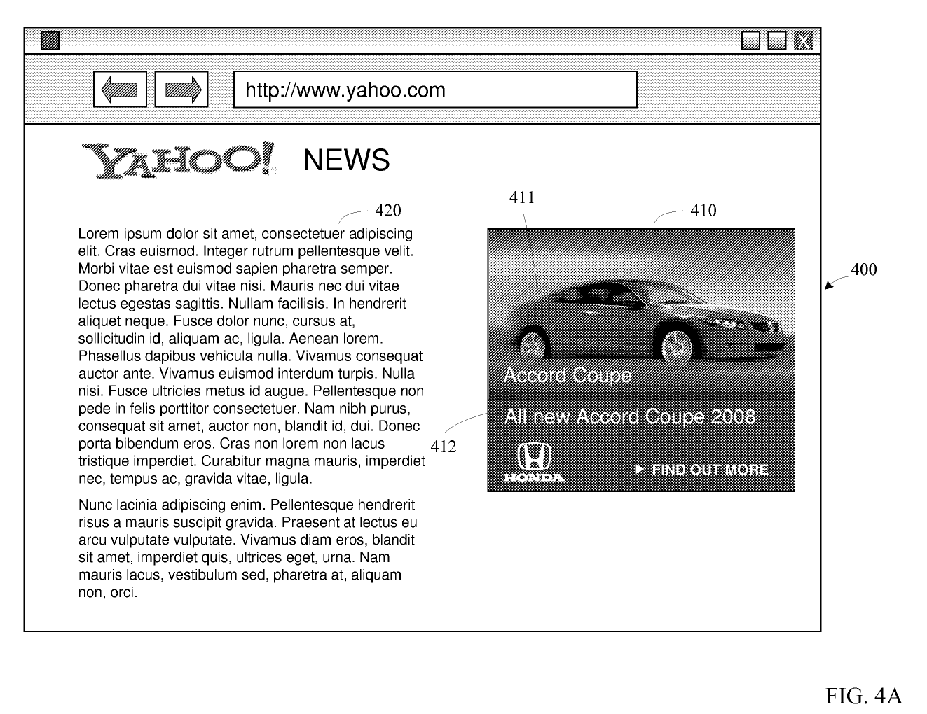

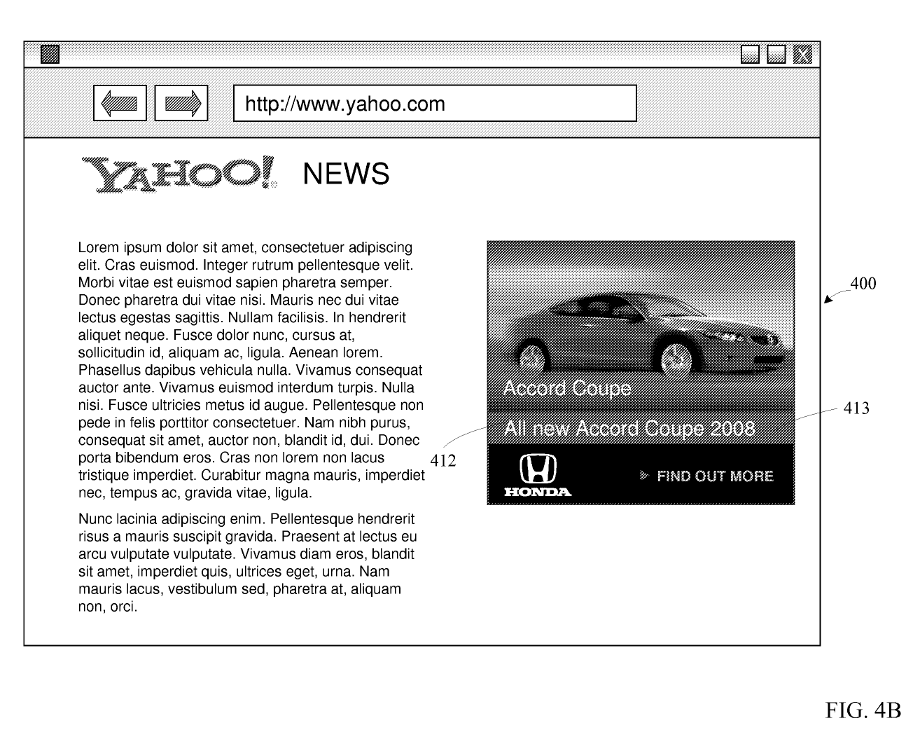

FIGS. 4A and 4B illustrate another sample web page 400 used for an advertisement constructed using the method illustrated in FIG. 2. In FIG. 4A, the web page 400 again contains an image 410 as one of its major elements (the other major element is the block of text 420). The image 410 shows a red car 411, which is the main theme of the image 410. For this example, the relevant-color rule specifies that the red color found in the image 410 is the relevant color, because the most relevant color of the image 410 is the color in the largest single-color contiguous region in the center of the image, which is the subject matter of the image 410. By analyzing the pixel values of the image, it may be determined that the bright red color 411 of the car is the brightest red color, and thus the relevant color. An alternative relevant-color rule may have specified that the most relevant color is the one at the hottest temperature, where color temperature is well-known to those skilled in the relevant arts, and would have again resulted in the red color being selected.

The augmenting-color rule in this example specifies that the background of one group of text 412 (“All new Accord Coupe 2008”) accompanying the image 410 is the same as the relevant color. Thus, in FIG. 4B, the web page is automatically constructed where the background color 413 of the text block 412 is the same as the red color 411 of the car.

The two examples shown in FIGS. 3A-3B and FIGS. 4A-4B respectively illustrate the advantages associated with some embodiments of the present invention. For example, by analyzing the pixel values of the image(s) systematically using a computer to select or identify a relevant color(s), the present invention provides a more accurate result. For example, in FIGS. 3A-3B, although the human eye may determine that there is more blue color in the image 310 than any other type of color, such as green or white, the human eye will not be able to distinguish the various shades of blue all found in the floor of the tennis court area or which shade of blue occurs more frequently than the others. Similarly, it would be almost impossible for the human eye to accurately determine which shade of red found in the car of the image 410 is the brightest shade of red.

Next, with the number of web pages to be constructed dynamically for each website (e.g., Yahoo!™ serves over one billion web pages per day), it would be impossible for human operators to manually select the relevant attribute(s) and augmenting attribute(s) for each web page fast enough. On the other hand, using a rule-based approach, once the relevant-attribute and augmenting-attribute rules have been defined, the same rules may be applied to multiple web pages and these web pages may be analyzed and constructed automatically, i.e., without human interaction.

From an application point of view, the method is especially advantageous for delivering image-oriented advertisement via dynamically generated web pages. The advertisement displayed on these web pages may change very frequently. It is likely that different ads are used every time a web page is generated. For example, Yahoo!™ may show over one million impressions of ads everyday. When viewing the web pages, people tend to ignore the ads displayed thereon unless there is something about the ads, such as from the way the ads are presented, that attracts their attentions. If a default layout scheme is used for different ads, the ads may not be presented in their best light, and as a result, their potential effectiveness may not be fully realized. On the other hand, if the layout scheme is automatically tailored to the images used in the ads, the ads may be able to attract the users' attentions more and thus become more effective.

Moreover, although in the various embodiments discussed above, the relevant attribute(s) are obtained by analyzing the image(s) to be displayed on a web page themselves, e.g., by analyzing the pixel values of the image(s), it is also possible to consider other types of data associated with the image(s) during the determination of the relevant attribute(s). For example, often times, an image may be associated with various types of metadata that describes different types of information with respect to the image, such as the content, concept, or theme of the image. In FIGS. 3A and 3B, the image 310 may have a metadata that indicates the image's concept is about “sports” or more specifically about “tennis”. In FIGS. 4A and 4B, the image 410 may have a metadata that indicates the image's concept is about “cars” or more specifically about “cars made by Honda”. Such metadata may be used when selecting the augmenting attribute(s) for the web page as well. For example, if the metadata of an image indicates that the theme of the image is about Apple computers, then the company's logo color may be considered when choosing an augmenting color, as governed by a particular augmenting-attribute rule. In another example, an image's name may contain descriptive information that may be used to determine information about the image itself, and such information may be considered when selecting the augmenting attribute(s).

In addition, although the various embodiments have been discussed in connection with the designing of web pages, the same concept applies to the designing of any publication that includes one or more images as its major or central components or elements. Of course, the advantages of the present invention are more noticeable in situations where a relatively great number of publications need to be designed and constructed in a relatively short amount of time, as in the case of web pages.

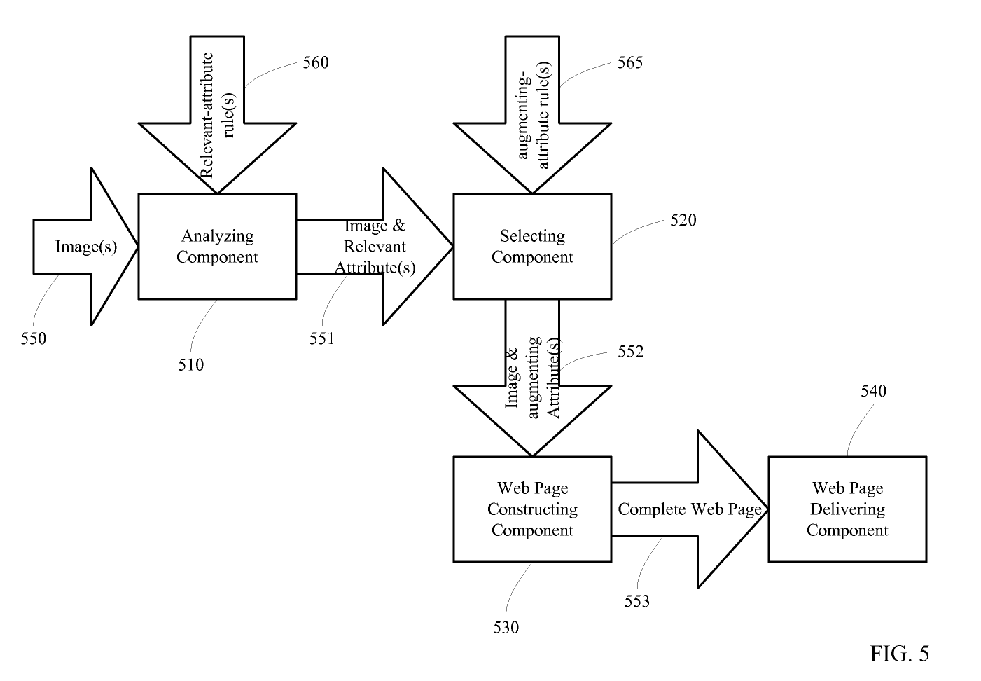

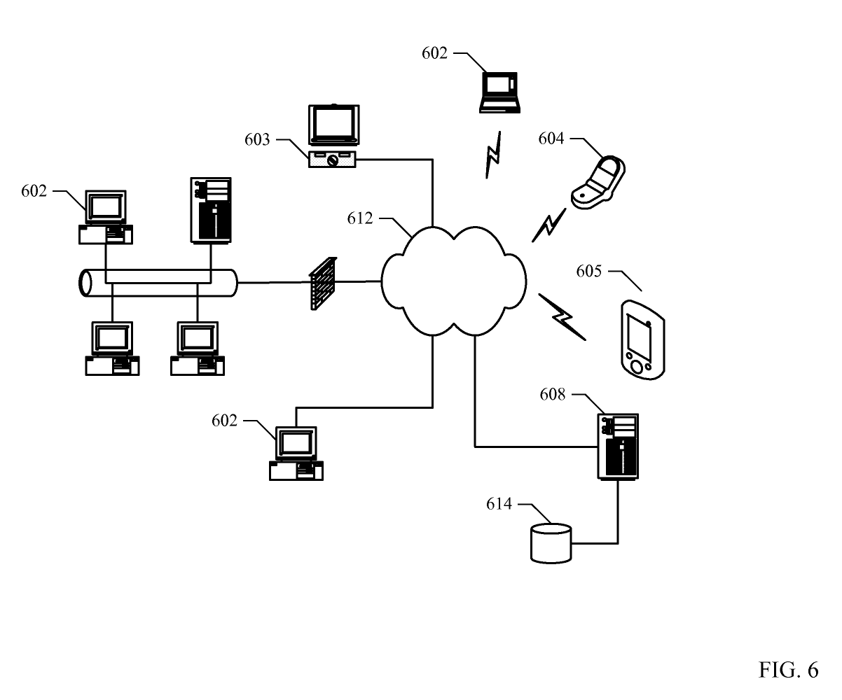

FIG. 5 illustrates a system for automatically analyzing the image(s) displayed on a web page and determining the layout characteristics for the web page based on the results of the analysis. The Analyzing Component 510 analyzes the image(s) 550 to be displayed on a web page based on the relevant-attribute rule(s) 560 to determine the relevant attribute(s) 551 found in the image(s) 550. The Selecting Component 520 automatically selects the augmenting attribute(s) 552 corresponding to the relevant attribute(s) 551 based on the augmenting-attribute rule(s) 565. The Web page Constructing Component 530 automatically and dynamically constructs the web page 553, incorporating the image(s) 550 and the augmenting attribute(s) 552 based on the augmenting-attribute rule(s) 565. Finally, the Web page Delivering Component 540 delivers the web page 540 to the users.

The various components shown in FIG. 5 are for illustrative purpose only. The actual design and implementation of the system may vary depending on the specific needs and requirements of the individual system. For example, various functionalities may be combined into one component, e.g., combining web page construction and delivery into a single component. Furthermore, the process may be implemented as a computer software program. A data structure may be defined to represent the various relevant-attribute and augmenting-attribute rules. Existing image processing algorithms and/or code libraries may be utilized for the analysis of the images, such as in the case of constructing a histogram for an image. Alternatively, new algorithms may be designed and implemented when appropriate.

FIG. 6 is a simplified diagram of a network environment in which specific embodiments of the present invention may be implemented. It will be understood that computer software programs implementing various aspects of the invention may be executed in such an environment.

The various aspects of the invention may be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations. All or a portion of the software program implementing various embodiments may be executed on the server 608. Similarly, a website may be hosted on the server 608 or by one of the computers 602, 603.

The predefined relevant-attribute and augmenting-attribute rules may be stored in a database 614 accessible by the server 608 executing the software program. The dynamically constructed web pages may be delivered to the users via various devices connected to the network 612, such as personal computers 602, 603, smart phones 604, PDAs (Personal Digital Assistant) 605, etc.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method of dynamically constructing a web page having at least one image as a major component of the web page, comprising:
analyzing the at least one image based on a first set of rules to determine at least one relevant attribute;
selecting at least one aesthetic design element with reference to the at least one relevant attribute based on a second set of rules; and
constructing the web page having the at least one image by incorporating the at least one aesthetic design element, wherein the analyzing, selecting, and constructing are performed automatically and without human intervention in response to a request for the web page.

2. The computer-implemented method, as recited in claim 1, wherein the at least one relevant attribute is at least one selected from a group consisting of color, shape, region, brightness, darkness, hue, saturation, and pixel value.

3. The computer-implemented method, as recited in claim 1, wherein the at least one aesthetic design element is at least one selected from a group consisting of HyperText Markup Language (HTML) properties, Adobe Flash™ interface properties, Adobe Flash™ Player interface properties, Sun Java™ applet interface properties, and Silverlight™ interface properties.

4. The computer-implemented method, as recited in claim 1, wherein analyzing the at least one image determines at least one relevant color.

5. The computer-implemented method, as recited in claim 4, wherein selecting the at least one aesthetic design element selects at least augmenting color for the web page with reference to the at least one relevant color.

6. The computer-implemented method, as recited in claim 4, wherein selecting the at least one aesthetic design element selects at least one border color for the at least one image respectively with reference to the at least one relevant color.

7. The computer-implemented method, as recited in claim 4, wherein selecting the at least one aesthetic design element selects at least one text font for the web page with reference to the at least one relevant color.

8. The computer-implemented method, as recited in claim 4, wherein selecting the at least one aesthetic design element selects at least one text color for the web page with reference to the at least one relevant color.

9. The computer-implemented method, as recited in claim 4, wherein selecting the at least one aesthetic design element selects at least one text border color for the web page with reference to the at least one relevant color.

10. The computer-implemented method, as recited in claim 1, further comprising:
delivering the web page to a user from which the request originated.

11. A computer-implemented system for dynamically constructing a web page having at least one image as a major component of the web page, comprising at least one computing device configured to:
analyzing the at least one image based on a first set of rules to determine at least one relevant attribute;
selecting at least one aesthetic design element with reference to the at least one relevant attribute based on a second set of rules; and
constructing the web page having the at least one image by incorporating the at least one aesthetic design element, wherein the analyzing, selecting, and constructing are performed automatically and without human intervention in response to a request for the web page.

12. The computer-implemented system, as recited in claim 11, wherein the at least one relevant attribute is at least one selected from a group consisting of color, shape, region, brightness, darkness, hue, and pixel value.

13. The computer-implemented system, as recited in claim 11, wherein the at least one aesthetic design element is at least one selected from a group consisting of HyperText Markup Language (HTML) property, Flash interface property, Flash Player interface property, Java applet interface property, and Silverlight™ interface property.

14. The computer-implemented system, as recited in claim 11, wherein analyzing the at least one image determines at least one relevant color.

15. The computer-implemented system, as recited in claim 14, wherein selecting the at least one aesthetic design element selects at least one augmenting color for the web page with reference to the at least one relevant color.

16. A computer program product for dynamically constructing a web page having at least one image as a major component of the web page, comprising a computer-readable medium having a plurality of computer program instructions stored therein, which are operable to cause at least one computing device to:
analyzing the at least one image based on a first set of rules to determine at least one relevant attribute;
selecting at least one aesthetic design element with reference to the at least one relevant attribute based on a second set of rules; and
constructing the web page having the at least one image by incorporating the at least one aesthetic design element, wherein the analyzing, selecting, and constructing are performed automatically and without human intervention in response to a request for the web page.

17. The computer program product, as recited in claim 16, wherein the at least one relevant attribute is at least one selected from a group consisting of color, shape, region, brightness, darkness, hue, and pixel value.

18. The computer program product, as recited in claim 16, wherein the at least one aesthetic design element is at least one selected from a group consisting of border color, background color, foreground color, text orientation, text font, text color, and text size.

19. The computer program product, as recited in claim 16, wherein analyzing the at least one image determines at least one relevant color.

20. The computer program product, as recited in claim 19, wherein selecting the at least one aesthetic design element selects at least one augmenting color for the web page with reference to the at least one relevant color.
